(19) United States
(12) Patent Application Publication
(10) Pub. No.: US 2021/0253859 A1
(43) Pub. Date: Aug. 19, 2021

(54) Dual Curable Silicone-Organic Hybrid Polymer Compositions for Liquid Optically Clear Adhesive Applications

(71) Applicant: Henkel IP & Holding GmbH, Duesseldorf (DE)

(72) Inventors: Laxmisha M. Sridhar, Monmouth Junction, NJ (US); Kevin J. Welch, Wallingford, CT (US)

(21) Appl. No.: 17/245,080

(22) Filed: Apr. 30, 2021

Related U.S. Application Data
(63) Continuation of application No. PCT/US2019/061909, filed on Nov. 18, 2019.
(60) Provisional application No. 62/768,313, filed on Nov. 16, 2018.
(60) Provisional application No. 62/777,960, filed on Dec. 11, 2018.

(51) Int. Cl. C08L 83/06; C09J 183/06

(52) U.S. Cl. CPC C08L 83/06; C09J 183/06

(57) ABSTRACT

The present disclosure provides dual curable compositions having both radiation curing and shadow curing mechanisms. The compositions comprise silicon-organic hybrid polymers having rapid shadow curing by a 2 part isocyanate-polyol reaction and/or a 2 part cyclic carbonate-amine reaction. The compositions can be used as adhesives or coatings. The use of the compositions according to the disclosure is particularly preferred for use in electro-optical components especially for automobile display adhesives applications.

### FIELD OF THE DISCLOSURE

This present disclosure relates generally to liquid optically clear adhesives, and more particularly to liquid optically clear adhesives that are dual curable and comprise silicone-organic hybrid polymers.

### BACKGROUND OF THE DISCLOSURE

This section provides background information which is not necessarily prior art to the inventive concepts associated with the present disclosure.

Highly integrated and sophisticated touch interface design is becoming increasingly important in many areas of technology that rely on touch screens. These include, by way of example only, mobile phone displays, display panels of registers in retail settings, display panels in food and beverage dispensers, camera display panels and automotive display panels. In the area of automotive display panels the need is especially important when it comes to enabling vehicle safety and user comfort with enhanced functionalities. In touch screen displays Liquid Optically Clear Adhesives (LOCA) are used to bond a plurality of the laminate layers to each other. These LOCAs typically must be able to bond uneven surfaces, be optically clear when cured and often needs to be dual curable, and must have good optical properties after aging over a wide range of environmental conditions. The LOCA also fills the air gaps between the laminate layers improving the overall viewing experience and clarity. The current LOCAs overcome limitations faced during traditional application methods by permitting automated processes with visible light cure options thereby enabling design flexibility. Some key requirements or complications that need to be overcome for LOCAs used in automobile display applications are: the presence of large shadow areas, which cannot be cured by light and need a secondary cure mechanism; the need to achieve visible light, >400 nm, light curing through plastic cover lens substrates or thick LOCA films; the need to achieve good lamination on plastic cover lenses made of, for example, poly(methyl methacrylate) (PMMA), polycarbonate (PC) or polyethylene terephthalate (PET) especially over a temperature range of from 100° C. to −40° C.; and exhibiting low haze and yellowing under conditions of high temperatures, high humidity and under strong UV radiation. Currently available organic or silicone based LOCA polymers cannot meet all of these requirements. Thus, there is a need to develop LOCA hybrid polymer resins and formulations to address these needs.

Currently available silicone-based LOCA polymers that are light and moisture curable have a low modulus and low glass transition temperatures. They sustain a wide temperature range of from −40° C. to 100° C., but have low compatibility with visible light photoinitiators and moisture cure catalysts. In addition, they have high moisture permeability, resulting in high haze under high temperature and high humidity conditions. Current organic polyacrylate-based LOCA polymers have good compatibility with photoinitiators and can have low moisture permeability, but always have high shrinkage and a wide range of glass transition temperatures, which causes defects or delamination on plastic substrates under −40° C. to 100° C. thermal cycling tests. Simple mixing a silicone-based LOCA polymer with an organic polyacrylate-based LOCA polymer results in haze due to incompatibility of the LOCA polymers.

It is desirable to provide a LOCA polymer or mixture of polymers that would address these shortcomings of the currently available LOCA polymers and that would find use in a variety of applications.

### SUMMARY OF THE DISCLOSURE

This section provides a general summary of the present disclosure and is not intended to be interpreted as a comprehensive disclosure of its full scope or all features, aspects and objectives.

The present disclosure presents silicone-organic hybrid polymers, which are composed of silicone blocks and significant, for example 2 wt. % to 30 wt. %, organic block content. These silicone hybrid polymers have improved compatibility with other organic monomers and photoinitiators in LOCA formulations. They exhibit lower moisture permeation than typical silicone-based LOCA polymers and lower shrinkage than organic polyacrylate-based LOCA polymers. These features are good for LOCA applications, especially for automobile displays.

One aspect of the present disclosure is to provide a dual curable composition comprising silicone-organic hybrid polymers.

One aspect of the present disclosure is to provide a dual curable composition comprising a combination of UV curable silicone-organic hybrid polymers and an isocyanate functional silicone hybrid polymer.

One aspect of the present disclosure is to provide a dual curable composition including:
a) a UV curable partially or fully (meth)acrylate end-capped silicone hybrid polymer;
b) a two component (2K) shadow curable composition comprising a combination of reactive components; and
c) other components such as organic diluent, photoinitiator, catalyst, adjuvants, and combinations thereof.

One aspect of the present disclosure is to provide a two-part. dual curable composition including:
a) a UV curable partially or fully (meth)acrylate end-capped silicone hybrid polymer;
b) a shadow curable component comprising a polymer mixture comprising:
   1) an isocyanate containing silicone hybrid polymer;
   2) One or more materials reactive with the isocyanate containing silicone hybrid polymer; and
c) a catalyst for the shadow cure reaction.

One aspect of the present disclosure is to provide a dual curable composition including:
a) a UV curable partially or fully (meth)acrylate end-capped silicone hybrid polymer;
b) a shadow curable component comprising a polymer mixture comprising:
   1) an isocyanate containing silicone hybrid polymer;
   2) a silicone hybrid polymer diol, a silicone polyol polymer and combinations thereof
c) a photoinitiator; and
d) a catalyst for the isocyanate containing polymer shadow cure reaction.

One aspect of the present disclosure is to provide a dual curable composition including:
a) a UV curable partially or fully (meth)acrylate end-capped silicone hybrid polymer;
b) a shadow curable component comprising a polymer mixture comprising:
   1) a polymeric silicone hybrid cyclic carbonate,
   2) one or more amine functional silicone polymers, and
   3) optionally one or more of shadow cure catalysts.

These and other features and advantages of this disclosure will become more apparent to those skilled in the art from the detailed description herein. The drawings that accompany the detailed description are described below.

### BRIEF DESCRIPTION OF THE DRAWINGS

The drawings described herein are for illustrative purposes only of selected aspects and not all implementations, and are not intended to limit the present disclosure to only that actually shown. With this in mind, various features and advantages of example aspects of the present disclosure will become apparent to one possessing ordinary skill in the art from the following written description and appended claims when considered in combination with the appended drawings, in which:

FIG. 1 is a graph showing the storage modulus vs time plot, and gap between the two glass test plates over a cure time of 6000 minutes after a 1 minute UV exposure for a silicone hybrid polymer containing adhesive composition, Formulation 1, according to the present disclosure.

### DETAILED DESCRIPTION OF THE DISCLOSURE

In the following description, details are set forth to provide an understanding of the present disclosure.

For clarity purposes, example aspects are discussed herein to convey the scope of the disclosure to those skilled in the relevant art. Numerous specific details are set forth such as examples of specific components, devices, and methods, in order to provide a thorough understanding of various aspects of the present disclosure. It will be apparent to those skilled in the art that specific details need not be discussed herein, such as well-known processes, well-known device structures, and well-known technologies, as they are already well understood by those skilled in the art, and that example embodiments may be embodied in many different forms and that neither should be construed to limit the scope of the disclosure.

The terminology used herein is for the purpose of describing particular example aspects only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

The term “about’ or “approximately” means within 25%, preferably 15%, more preferably 5%, and most preferably 1% of the given value. Alternatively, the term “about” means the standard deviation or variance for a given value, if available.

The term “alkyl” or an “alkenyl” has the broadest meaning in the art and can be linear, branched, cyclic or a combination thereof having the specified number of carbon atoms and it may be substituted.

The term “aliphatic” means a hydrocarbon moiety having the specified number of carbon atoms and it can be linear, branched, cyclic or a combination thereof, it can be fully saturated or contain unsaturation so long as it is not aromatic.

The term “aryl” refers to an aromatic group having the specified number of carbon atoms.

The term “aralkyl” refers to an alkyl group substituted with an aryl group with the specified number of carbon atoms and it can be substituted.

The term “dual cure” refers to a composition comprising a first component that is radiation curable, for example curable by exposure to ultraviolet (UV) radiation and a second component including materials that form reaction products when mixed, for example a first isocyanate comprising material and a second hydroxyl group containing material. As used herein a dual cure material excludes compositions that rely on moisture or water initiated curing reactions.

The term “hydrocarbylene” refers to any divalent radical derived from a hydrocarbon. Some exemplary hydrocarbylenes are linear or branched alkylenes, cycloalkylenes, bicycloalkylenes, tricycloalkylenes, linear or branched alkylcycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, polyoxyalkylenes and mixtures thereof. Hydrocarbylene groups can be unsubstituted or substituted.

The term “heterocarbylene” means a divalent hydrocarbylene group that contains a heteroatom such as oxygen, sulfur, or nitrogen incorporated within the chain or ring. Heterocarbylene groups can be unsubstituted or substituted.

The term “(meth)acrylate” means both acrylate and methacrylate monomers and combinations thereof and the polymers formed from them. Therefore a (meth)acrylate polymer can comprise methacrylate monomers, acrylate monomers or mixtures thereof.

The term “LOCA” means Liquid Optically Clear Adhesive. For purposes of this disclosure an adhesive will be considered to be optically clear if it exhibits an optical transmission of at least about 85%. The measurement of optical transmission is known to the person skilled in the art. It can preferably be measured on a 300 μm thick sample according to the following preferred testing method. The preferred testing method for transmission includes: placing a small drop of optically clear adhesive placed on a 75 mm by 50 mm plain micro slide (a Gorilla glass slide from Corning) that has been wiped with isopropanol and has two 300 μm thick spacer kept on its two ends. A second glass slide is attached onto the adhesive under a force. Then the adhesive is fully cured under a UV source and left at room temperature overnight for shadow curing. The optical transmission is measured from wavelength 380 nm to 780 nm with a spectrometer Datacolor 650 from Technical color solutions. One blank glass slide is used as the background.

The term “molecular weight” refers to number average molecular weight unless otherwise specified. The number average molecular weight Mₙ, as well as the weight average molecular weight M_{w}, is determined according to the present invention by gel permeation chromatography (GPC, also known as SEC) at 23° C. using a polystyrene standard. This method is known to one skilled in the art.

The term “optional” or “optionally” means that the subsequently described circumstance may or may not occur, so that the description includes instances where the circumstance occurs and instances where it does not. The term “preferred” and “preferably” are used to refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure. The term “shadow cure” refers to the ability of an adhesive to cure in areas that are not exposed to UV light. Shadow curable LOCAs find use in applications wherein at least some portions of the LOCA cannot be exposed to UV light.

The term “silicone hybrid polymer” includes the silicone-organic hybrid polymers formed according to any of the processes of the present disclosure.

The term “substituted” means the parent structure has one or more hydrogen atoms replaced with a chemical group, which does not adversely affect the desired composition. Some exemplary chemical replacement groups are amino, phosphino, quaternary nitrogen (ammonium), quaternary phosphorous (phosphonium), hydroxyl, amide, alkoxy, mercapto, nitro, alkyl, halo, sulfone, sulfoxide, phosphate, phosphite, carboxylate, carbamate groups.

The following abbreviations are used herein: g for gram, mg for milligram, ml for milliliter, L for liter, mm for millimeter, sec for seconds, ° C. for degrees Celsius, LOCA for Liquid Optically Clear Adhesive, nm for nanometers of wavelength, PMMA for poly(methyl methacrylate), PC for polycarbonate, PET for polyethylene terephthalate, and mmol for millimoles.

The disclosed silicone hybrid polymers typically possess significant organic content. In some embodiments the silicone hybrid polymers comprise about 2 wt. % to about 30 wt. % organic content based on carbon and hydrogen atom content. This organic content provides compatibility of the silicone hybrid polymers with other organic polymers/monomers in LOCA formulations. These silicone hybrid polymers and the LOCA formulations containing these polymers have good compatibility with visible light organic photoinitiators and moisture cure catalysts as well. They exhibit lower moisture permeation than typical silicone-based LOCA polymers and lower shrinkage than organic polyacrylate-based LOCA polymers. These features are good for LOCA applications, especially for automobile displays.

For a UV curable silicone hybrid polymer organic and silicone segments are combined by reacting a dihydroxy functional silicone polymer with an organic diisocyanate to form a silicone-organic block polymer with a clear appearance. Depending on the ratio of dihydroxy functional silicone polymer to organic diisocyanate used in the reaction, either hydroxy-terminated or isocyanate-terminated silicone-organic block polymers can be made. The hydroxy-terminated silicone hybrid polymers can then be further partially or completely end-capped with isocyanate containing (meth)acrylates in a one-pot process to produce photo curable silicone hybrid polymers. Commercially available isocyanate compounds containing (meth)acrylate moieties can be used for the above capping process.

For a shadow curable silicone hybrid polymer, the isocyanate-terminated silicone hybrid polymers can be formulated with one or more of hydroxy-terminated or pendant silicone hybrid polymers described above and/or commercially available hydroxy functional silicone polymers to provide a two-part system. The two-part system is non-reactive when the isocyanate and hydroxy components are separated but starts to react when the components are mixed. Alternatively, a silicone hybrid polymer comprising cyclic carbonate moieties can be used as one component and amine functional silicones can be used as the second component. The two-part system is non-reactive when the cyclic carbonate and amine components are separated but starts to react when the components are mixed.

A dual curable system will typically comprise a UV curable silicone hybrid polymer, reactive shadow curable silicone hybrid polymer components and other components such as organic diluent polymer, photoinitiator, catalyst, adjuvants, and combinations thereof. In one embodiment the dual curable LOCA composition will comprise: partially or fully (meth)acrylate end-capped silicone hybrid polymer(s); isocyanate-terminated silicone hybrid polymer(s); hydroxy-terminated silicone hybrid polymer(s); optionally hydroxyl containing silicone polyol polymer(s); an organic diluent polymer; at least one photoinitiator; at least one shadow cure catalyst; and optionally one or more adjuvants. In another embodiment the dual curable LOCA composition will comprise: partially or fully (meth)acrylate end-capped silicone hybrid polymer(s); cyclic carbonate terminated silicone hybrid polymer(s); amine containing silicone hybrid polymer(s); an organic diluent polymer; at least one photoinitiator; at least one catalyst; and optionally one or more adjuvants.

Naturally, the components of the dual curable system are packaged in a two-part system to prevent reaction of the shadow curable components and provide commercially useful storage life before use. The two parts are mixed just before use.

In one embodiment the curable composition will typically have the following components and concentrations.

| | | preferred range |
|---|---|---|
| component | range (wt. %) | (wt. %) |
| UV curable component | | |
| (meth)acrylate end-capped silicone | 10-90 | 30-70 |
| hybrid polymer | | |
| shadow curable component | | |
| isocyanate-terminated silicone | 10-90 | 30-70 |
| hybrid polymer | | |
| hydroxy-terminated silicone | 2-50 | 10-20 |
| hybrid polymer | | |
| hydroxyl containing silicone | 1-30 | 2-20 |
| polyol polymer | | |
| other components | | |
| organic diluent | 1-10 | 3-6 |
| photoinitiator | 0.05-5 | 0.1 to 0.5 |
| catalyst | 0.01-2 | 0.01-0.2 |
| adjuvants | 0-60 | 0.1-1 |

In one embodiment the curable composition will typically have the following components and concentrations.

| | | preferred range |
|---|---|---|
| component | range (wt. %) | (wt. %) |
| UV curable component | | |
| (meth)acrylate end-capped silicone | 10-90 | 30-70 |
| hybrid polymer | | |
| shadow curable components | | |
| cyclic carbonate terminated silicone | 10-90 | 20-60 |
| hybrid polymer | | |
| amine containing silicone | 2-30 | 5-30 |
| hybrid polymer | | |
| other components | | |
| organic diluent | 1-10 | 2-6 |
| photoinitiator | 0.05-5 | 0.1-0.5 |
| catalyst | 0.01-0.5 | 0.01-0.3 |
| adjuvants | 0-60 | 0.1-0.5 |

The mixed adhesive is disposed onto a first substrate to be bonded. Mixing initiates reaction of the shadow curable components. The disposed adhesive is exposed to radiation, such as UV light, to initiate UV curing. A second substrate can be placed over the curing adhesive to bond the second substrate to the first substrate. Alternatively, if one or both of the substrates sufficiently transparent to UV light, the mixed adhesive can be disposed between the first and second substrates and irradiated by UV light through one or both substrates.

Partially or Fully (meth)acrylate End-Capped Silicone Hybrid Polymer(s);

One partially or fully (meth)acrylate end-capped silicone hybrid polymer is shown in structure I

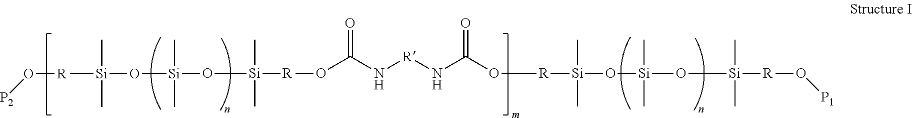

R and R′ are each independently hydrocarbylene segments having 1 to 30 carbon atoms or heterocarbylene. segments having 1 to 30 carbon atoms and one or more of nitrogen, oxygen or sulfur atoms in the backbone. Preferably, R and R′ are each independently organic segments selected from the group consisting of linear or branched alkylenes, cycloalkylenes, bicycloalkylenes, tricycloalkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, polyoxyalkylenes, heterocycloalkylene, heterocycloarylenes and mixtures thereof; optionally, the alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, polyoxyalkylenes, heterocycloalkylene, heterocycloarylenes and mixtures thereof can contain one or more of oxygen or sulfur atoms in the backbone. More preferably, R and R′ are each independently selected from an alkylene or cycloalkylene having 4 to 20 carbon atoms and alkylene or cycloalkylene ethers having 4 to 20 carbon atoms and one or more oxygen atoms.

P₁ and P₂ can be independently H or a polymerizable group derived from reaction of a hydroxyl group with an isocyanate containing (meth)acrylate group with the proviso that only one of P₁ and P₂ can be H.

n and m are independently 1 to 10,000. Preferably, n is 1 to 1,000 and m is 1 to 20.

Partially or fully (meth)acrylate end-capped silicone hybrid polymers according to the present disclosure are generally prepared by reacting more than a stoichiometric excess of dihydroxy functional silicone polymers with an organic diisocyanate to form a hydroxy-terminated silicone and organic copolymer; followed by end-capping of that hydroxy-terminated silicone-organic copolymer with an isocyanate functional (meth)acrylate. By changing the ratio of diol to diisocyanate, although still keeping the diol in excess, the viscosity of the resulting (meth)acrylate end-capped silicone hybrid polymer can be tuned to be suitable for a given application. Commercially available hydroxy-terminated silicone polymers include KF-6000, 6001, 6002 and 6003 available from Shin-Etsu; X-22-4952, X-22-4272, KF-6123, X-21-5841 and KF-9701 available from Shin Etsu; or Silmer OHT A0, Silmer OH Di-10, Silmer OH di-50 available from Siltech Corporation. Organic diisocyanates that can be used for reaction with the silicone diols include, but are not limited to, isophorone diisocyanate (IPDI), IPDI trimer, polymeric IPDI, naphthalene 1,5-diisocyanate (NDI), methylene bis-cyclohexylisocyanate, methylene diphenyl diisocyanate (MDI), polymeric MDI, toluene diisocyanate (TDI), isocyanurate of TDI, TDI-trimethylolpropane adduct, polymeric TDI, hexamethylene diisocyanate (HDI), HDI isocyanurate, HDI biurate, polymeric HDI, xylylene diisocyanate, hydrogenated xylylene diisocyanate, tetramethyl xylylene diisocyanate, p-phenylene diisocyanate, 3,3′-dimethyldiphenyl-4,4′-diisocyanate (DDDI), 2,2,4-trimethylhexamethylene diisocyanate (TMDI), norbornane diisocyanate (NDI), and 4,4′-dibenzyl diisocyanate (DBDI) and combinations thereof. Preferred aliphatic diisocyanates include hexamethylene diisocyanate (HDI), isophorone diisocyanate (IPDI), pentamethylenediisocyanate, TAKENATE™ 600 (1,3, Bis(isocyanatemethyl)cyclohexane), TAKENATE™ D-120N (an aliphatic polyisocyanate adduct based on hydrogenated xylylene diisocyanate), both available from Mitsui Chemicals, and 4,4′-methylene dicyclohexyl diisocyanate (H12-MDI). Aliphatic and cycloaliphatic diisocyanates and polyisocyanates are preferred since aromatic diisocyanates contribute to color and higher viscosity of the resulting copolymers, which is not desired for this application.

Hydroxy-terminated silicone Hybrid Polymer(s):

The same approach used to prepare the partially or fully (meth)acrylate end-capped silicone hybrid polymers can also be used to make hydroxy terminated silicone hybrid polymers by skipping the final acrylate end-capping step. These silicone hybrid polymer diols can be used as one part of the shadow curable formulation alone or in combination with other silicone diols or polyols. See the structural reaction sequence below.

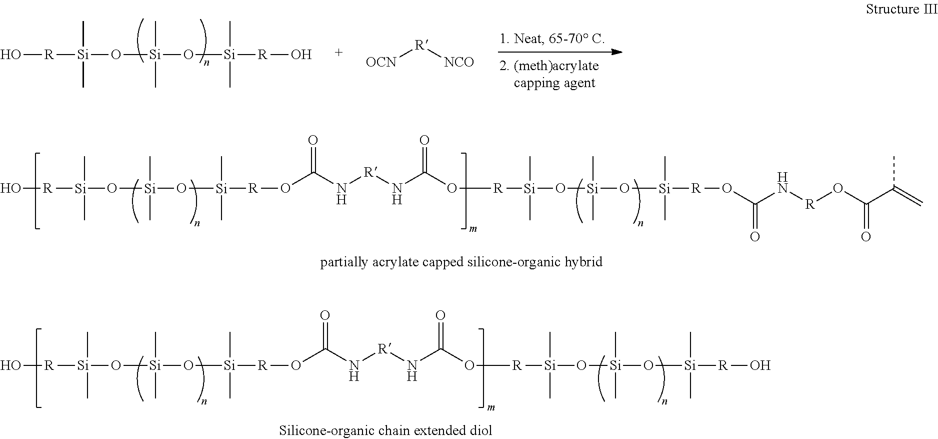

R and R′ are each independently hydrocarbylene segments having 1 to 30 carbon atoms or heterocarbylene segments having 1 to 30 carbon atoms and one or more of nitrogen, oxygen or sulfur atoms in the backbone. Preferably, R and R′ are each independently organic segments selected from the group consisting of linear or branched alkylenes, cycloalkylenes, bicycloalkylenes, tricycloalkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, polyoxyalkylenes, heterocycloalkylene, heterocycloarylenes and mixtures thereof; optionally, the alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, polyoxyalkylenes, heterocycloalkylene, heterocycloarylenes and mixtures thereof can contain one or more of O or S in the backbone. More preferably, R and R′ are each independently selected from an alkylene having 4 to 20 carbon atoms, a cycloalkylene having 4 to 20 carbon atoms, an alkylene ethers having 4 to 20 carbon atoms and one or more oxygen atoms or a cycloalkylene ether having 4 to 20 carbon atoms and one or more oxygen atoms.

n and m are each independently 1 to 10000. Preferably, n is 1 to 1,000 and m is 1 to 20.

Silicone polyol polymer(s):

One silicone polyol polymer is shown in structure IV.

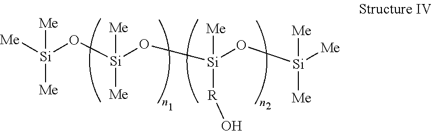

R is a hydrocarbylene having 1 to 30 carbon atoms or heterocarbylene having 1 to 30 carbon atoms and one or more of nitrogen, oxygen or sulfur atoms in the backbone. Preferably, R is an alkylene or cycloalkylene segment containing 1-30 carbon atoms.

n1 is 1 to 10,000 and preferably 1 to 1,000. n2 is 2 to 10,000, preferably 2 to 100.
Another silicone polyol polymer is shown in structure IVa.

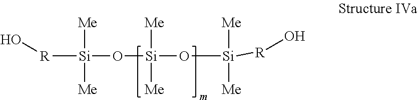

R is a hydrocarbylene having 1 to 30 carbon atoms or heterocarbylene having 1 to 30 carbon atoms and one or more of nitrogen, oxygen or sulfur atoms in the backbone. Preferably, R is an alkylene or cycloalkylene segment containing 1-30 carbon atoms.
m is 1 to 10,000 and preferably 1 to 1,000.
Isocyanate-terminated silicone hybrid polymer(s):

Isocyanate-terminated silicone hybrid polymers can be made using a similar process as the partially or fully (meth)acrylate end-capped silicone hybrid polymer and the same reactants, however using a stoichiometrically excess amount of the diisocyanate as shown below.

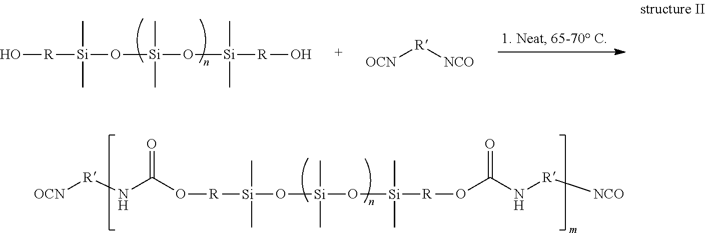

R and R′ are each independently hydrocarbylene having 1 to 30 carbon atoms or heterocarbylene having 1 to 30 carbon atoms and one or more of nitrogen, oxygen or sulfur atoms in the backbone. Preferably, R and R′ are each independently organic segments selected from the group consisting of alkylenes, cycloalkylenes, bicycloalkylenes, tricycloalkylenes, linear or branched alkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, polyoxyalkylenes, heterocycloalkylene, heterocycloarylenes and mixtures thereof; optionally, the alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, polyoxyalkylenes, heterocycloalkylene, heterocycloarylenes and mixtures thereof can contain one or more of O or S in the backbone. More preferably, R and R′ are each independently selected from an alkylene having 4 to 20 carbon atoms, cycloalkylene having 4 to 20 carbon atoms, an alkylene ether having 4 to 20 carbon atoms or a cycloalkylene ether having 4 to 20 carbon atoms and one or more oxygen atoms.

n and m are each independently 1 to 10000. Preferably, n is 1 to 1,000 and m is 1 to 20.

Alternatively, isocyanate-terminated silicone hybrid polymers can also be obtained by addition of mercapto functional silicones to organic diisocyanates. Structure IIa illustrates one embodiment of this isocyanate-terminated silicone hybrid polymer.

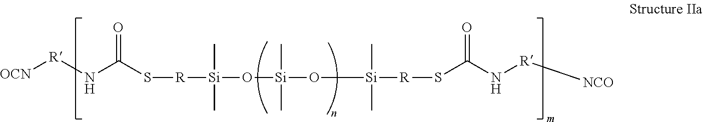

R, R′, n and m are same as described above. Example 6, herein, describes the synthesis of the Structure IIa isocyanate-terminated silicone-thiourethane hybrid polymer according to the present disclosure by addition of mercapto functional silicones to more than a stoichiometric amount of organic diisocyanates. Examples of mercaptan functional silicones that can be used for the synthesis of isocyanate-terminated silicone-thiourethane hybrid polymers include X-22-167B, X-22-167C, which are available from Shin-Etsu, and GP-970 which is available from Genesee Polymers.

### Cyclic Carbonate Terminated Silicone Hybrid Polymer:

A cyclic carbonate terminated silicone hybrid polymer is shown in structure V.

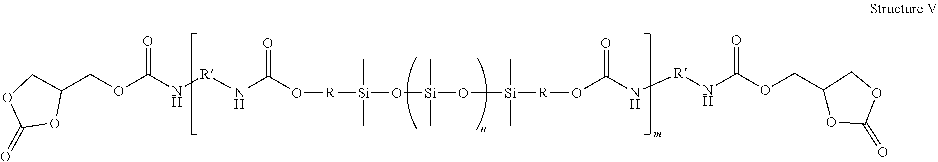

R and R′ are each independently hydrocarbylene segments having 1 to 30 carbon atoms or heterocarbylene segments having 1 to 30 carbon atoms and one or more of nitrogen, oxygen or sulfur atoms in the backbone. Preferably, R and R′ are each independently organic segments selected from the group consisting of linear or branched alkylenes, cycloalkylenes, bicycloalkylenes, tricycloalkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, polyoxyalkylenes, heterocycloalkylene, heterocycloarylenes and mixtures thereof; optionally, the alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, polyoxyalkylenes, heterocycloalkylene, heterocycloarylenes and mixtures thereof can contain one or more of O or S in the backbone. More preferably, R and R′ are each independently selected from an alkylene or cycloalkylenes having 4 to 20 carbon atoms and alkylene or cycloalkylene ethers having 4 to 20 carbon atoms and one or more oxygen atoms.

n and m are each independently 1 to 10000. Preferably, n is 1 to 1,000 and m is 1 to 20.

### Silicone Amine Polymer:

Some exemplary silicone amine polymers are shown in Structures VI and VII.

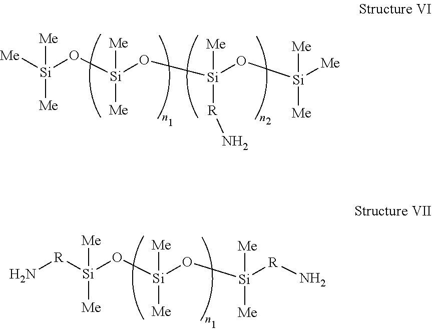

R is a hydrocarbylene having 1 to 30 carbon atoms or heterocarbylene having 1 to 30 carbon atoms and one or more of nitrogen, oxygen or sulfur atoms in the backbone. Preferably, R is alkylene or cycloalkylene segment containing 1-30 carbon atoms.

n1 is 1 to 10,000 and preferably 1 to 1,000. n2 is 2 to 10,000, preferably 2 to 100.

### Organic Diluent:

The organic diluent is a low viscosity, reactive diluent, monomer or reactive diluent polymer. The organic diluent can be a liquid having a viscosity of 5 cP to 3,000 cP at room temperature. The organic diluent may comprise mono-functional (meth)acrylates, (meth)acrylamides, (meth)acrylic acid and combinations thereof. Illustrative examples of useful mono-functional (meth)acrylates, include alkyl (meth)acrylates, cycloalkyl (meth)acrylates, alkenyl (meth)acrylates, heterocycloalkyl (meth)acrylates, heteroalkyl methacrylates, alkoxy polyether mono(meth)acrylates.

The alkyl group on the (meth)acrylate desirably may be a substituted or unsubstituted alkyl group having 1 to 20 carbon atoms, desirably 1 to 10 carbon atoms, optionally having at least one substituent selected from an alkyl group having 1 to 10 carbon atoms, substituted or unsubstituted cycloalkyl group having 1 to 20 carbon atoms, desirably 1 to 10 carbon atoms, substituted or unsubstituted bicyclo or tyricycloalkyl group having 1 to 20 carbon atoms, desirably 1 to 15 carbon atoms, an alkoxy group having 1 to 10 carbon atoms, an aryloxy group having 6 to 10 carbon atoms.

The alkenyl group on the (meth)acrylate desirably may be a substituted or unsubstituted alkenyl group having 2 to 20 carbon atoms, desirably 2 to 10 carbon atoms, optionally having at least one substituent selected from an alkyl group having 1 to 10 carbon atoms, an alkoxy group having 1 to 10 carbon atoms, an aryloxy group having 6 to 10 carbon atoms, an epoxy group having 2 to 10 carbon atoms, hydroxyl and the like.

The heterocyclo group on the (meth)acrylate desirably may be a substituted or unsubstituted heterocyclo group having 2 to 20 carbon atoms, desirably 2 to 10 carbon atoms, containing at least one hetero atom selected from N and O, and optionally having at least one substituent selected from an alkyl group having 1 to 10 carbon atoms, an alkoxy group having 1 to 10 carbon atoms, an aryloxy group having 6 to 10 carbon atoms, or an epoxy group having 2 to 10 carbon atoms.

The alkoxy polyether mono(meth)acrylates can be substituted with an alkoxy group having 1 to 10 carbons and the polyether can have 1 to 10 repeat units.

Specific examples of mono-functional (meth)acrylate reactive diluents include, but are not limited to, methyl (meth)acrylate, ethyl (meth)acrylate, butyl (meth)acrylate, tetrahydrofuryl (meth)acrylate, lauryl acrylate, isooctyl acrylate, isodecyl acrylate, 2-ethylhexyl acrylate, isobornyl (meth)acrylate, dicyclopentenyl (meth)acrylate, octadecyl acrylate, 2-hydroxyethyl (meth)acrylate, 2-hydroxypropyl (meth)acrylate, 2-hydroxybutyl (meth)acrylate, 2-(2-ethoxyethoxy)ethyl acrylate, 2-phenoxyethyl acrylate, dicyclopentadienyl (meth)acrylate, dicyclopentenyloxyethyl (meth)acrylate, morpholine (meth)acrylate, isobornyl (meth)acrylate, N,N,dialkyl acrylamide, 2-methoxyethyl (meth)acrylate, 2(2-ethoxy)ethoxy ethyl acrylate and caprolactone acrylate.

Useful (meth)acrylamides may be unsubstituted (meth)acrylamides, N-alkyl substituted (meth)acrylamides or N,N-dialkyl substituted (meth)acrylamides. In the N-alkyl substituted (meth)acrylamides, the alkyl substituent desirably has 1 to 8 carbon atoms, such as N-ethyl acrylamide, N-octyl acrylamide and the like. In the N,N-dialkyl substituted (meth)acrylamides, the alkyl substituent desirably has 1 to 4 carbon atoms, such as N,N-dimethyl acrylamide and N,N-diethyl acrylamide.

The organic diluent is desirably a low viscosity liquid that is compatible with silicone hybrid polymer at normal temperature. The term “normal temperature” or “room temperature” means about 25° C.

### Photoinitiator:

The adhesive compositions can optionally include a photoinitiator component in amount useful to effectuate cure. Useful, non-limiting examples of photoinitiators include, one or more selected from the group consisting of benzyl ketals, hydroxyl ketones, amine ketones and acylphosphine oxides, such as 2-hydroxy-2-methyl-1-phenyl-1-acetone, diphenyl (2,4,6-triphenylbenzoyl)-phosphine oxide, 2-benzyl-dimethylamino-1-(4-morpholinophenyl)-butan-1-one, benzoin dimethyl ketal dimethoxy acetophenone, a-hydroxy benzyl phenyl ketone, 1-hydroxy-1-methyl ethyl phenyl ketone, oligo-2-hydoxy-2-methyl-1-(4-(1-methyvinyl)phenyl)acetone, benzophenone, methyl o-benzyl benzoate, methyl benzoylformate, 2-diethoxy acetophenone, 2,2-d isec-butoxyacetophenone, p-phenyl benzophenone, 2-isopropyl thioxanthenone, 2-methylanthrone, 2-ethylanthrone, 2-chloroanthrone, 1,2-benzanthrone, benzoyl ether, benzoin ether, benzoin methyl ether, benzoin isopropyl ether, α-phenyl benzoin, thioxanthenone, diethyl thioxanthenone, 1,5-acetonaphthone, 1-hydroxycyclohexylphenyl ketone, ethyl p-dimethylaminobenzoate. These photoinitiators may be used individually or in combination which each other.

Photoinitiators may be used in non-limiting amounts of about 0.05% by wt. to about 3.0% by wt. of the total composition, and desirably in about 0.1% by wt. to about 1.0% by wt. of the total composition.

In one preferred embodiment the photoinitiator is_Bis(2,4,6-trimethylbenzoyl)-phenylphosphineoxide or Irgacure 819.

### Catalyst:

The catalyst can be any catalyst for isocyanate reaction with hydroxyl. Some examples include amine catalysts such as 2,2′-dimorpholinodiethylether and triethylenediamine and organometallic catalysts such as dibutyltin dilaurate, dibutyltin dioctoate, Bismuth carboxylate catalysts that are available with the tradename K Kcat XK640, Zr based catalysts such as K Kat A 209 that is available from King industries. Zr based catalysts are preferred as the resulting isocyanate terminated silicone resin shows superior shelf life as compared to when tin or bismuth catalysts are used for the urethane synthesis. The catalyst is preferably present in an amount of from 0.005 to 3.5 wt. % based on the total composition weight.

### Optional Adjuvants:

Optional adjuvants include one or more of plasticizer, filler, adhesion promoter, moisture scavenger, UV stabilizer, shelf life stabilizer, rheological auxiliary, pigment and solvent.

The LOCA composition can optionally comprise one or more plasticizers to adjust the elastic properties and to improve the processability of the composition. A plasticizer is understood to be a substance which reduces the viscosity of the composition and thus makes processing easier, and in addition improves flexibility and extensibility of the compositions. The plasticizer may be selected from a fatty acid ester, a dicarboxylic acid ester except cyclohexanedicarboxylic acid dialkyl ester, an ester of epoxidized fatty acids or fatty acids carrying OH groups, a fat, a glycolic acid ester, a benzoic acid ester, a phosphoric acid ester, a sulfonic acid ester, a trimellitic acid ester, an epoxidized plasticizer, a polyether plasticizer, a polystyrene, a hydrocarbon plasticizer, a chlorinated paraffin and mixtures of two or more thereof. By the careful selection of one of plasticizer or of a specific combination of plasticizers, further advantageous properties of the composition according to the disclosure, for example gelling properties of the polymers, low-temperature elasticity or low-temperature resistance or antistatic properties, can be achieved. Among the polyether plasticizers, preferably end-capped polyethylene glycols are used, for example polyethylene or polypropylene glycol di-C₁₋₄-alkyl ethers, in particular the dimethyl or diethyl ethers of diethylene glycol or dipropylene glycol, and mixtures of two or more thereof. Also, suitable as plasticizers are, for example, esters of abietic acid, butyric acid ester, acetic acid ester, propionic acid ester, thiobutyric acid ester, citric acid ester and esters based on nitrocellulose and polyvinyl acetate, as well as mixtures of two or more thereof. Also suitable are, for example, the asymmetrical esters of adipic acid monooctyl ester with 2-ethylhexanol (Edenol DOA, Cognis Deutschland GmbH, Düsseldorf). In addition, the pure or mixed ethers of monofunctional, linear or branched C4-16 alcohols or mixtures of two or more different ethers of such alcohols are suitable as plasticizers, for example dioctyl ether (available as Cetiol OE, Cognis Deutschland GmbH, Düsseldorf). Likewise suitable as plasticizers within the framework of the present disclosure are diurethanes, which can be produced e.g. by reaction of diols having OH end groups with monofunctional isocyanates, by selecting the stoichiometry so that substantially all free OH groups react fully. Any excess isocyanate can then be removed from the reaction mixture, e.g. by distillation. Another method for producing diurethanes consists in the reaction of monofunctional alcohols with diisocyanates, wherein as far as possible all NCO groups react fully. If used, the total quantity of plasticizer(s) in curable compositions according to the invention is from 0 wt. % to 30 wt. %, preferably 5 wt. % to 25 wt. % and particularly preferably 10 wt. % to 20 wt. %, based in each case on the total weight of the curable composition.

The LOCA composition according to the disclosure can optionally comprise one or more filler(s). Some useful fillers include chalk, powdered limestone, precipitated and/or pyrogenic silica, zeolites, bentonites, calcium carbonate, magnesium carbonate, kieselguhr, alumina, clay, tallow, titanium oxide, iron oxide, zinc oxide, sand, quartz, flint, mica, powdered glass and other ground minerals. Organic fillers can also be used. Some useful organic fillers include carbon black, graphite, wood fibers, wood flour, sawdust, cellulose, cotton, pulp, wood chips, chopped straw, chaff, ground walnut shells and other short-cut organic fibers. Other short fibers such as glass fibers, glass filament, polyacrylonitrile, carbon fibers, Kevlar fibers or polyethylene fibers can also be useful as filler. Aluminum powder is also suitable as a filler. Hollow spheres with a mineral shell or a plastic shell are suitable as fillers. These can be e.g. hollow glass spheres which are commercially available with the trade names Glass Bubbles®. Plastic-based hollow spheres are commercially available, e.g. with the names Expancel® or Dualite®. These have a diameter of 1 mm or less, preferably of 500 μm or less. For some applications, fillers which make the preparations thixotropic are preferred. These fillers are also described as rheological auxiliaries, for example hydrogenated castor oil, fatty acid amides or swellable plastics such as PVC. The filler(s) are preferably used in a quantity of 0 wt. % to 50 wt. %, preferably 1 wt. % to 20 wt. %, more preferably 1 wt. % to 10 wt. %, based on the total weight of the composition.

The LOCA composition according to the present disclosure can optionally comprise UV stabilizers. Some useful UV stabilizers are the hindered amine light stabilizers (HALS). A UV stabilizer which carries a silyl group allowing it to be incorporated into the end product during crosslinking or curing can also be used. Furthermore, benzotriazoles, benzophenones, benzoates, cyanoacrylates, acrylates, sterically hindered phenols, phosphorus and/or sulfur can also be useful. The proportion of UV stabilizer(s) in the composition is about 0.05 wt. % to 2 wt. %, in particular 0.05 wt. % to 1 wt. %, based on the total weight of the composition.

It can be useful to stabilize the adhesive composition against premature curing caused by moisture penetration in order to increase the shelf life even more. This can be achieved by the use of moisture scavenger or drying agents. The adhesive composition can optionally comprise moisture scavenger or drying agent. Useful drying agents are all compounds that react with water to form a group that is inert towards the reactive groups present in the composition while undergoing only small changes in their molecular weight. Naturally, the reactivity of the drying agents towards moisture that has penetrated into the composition must be higher than the reactivity of the amino silane end groups of the terpolymer in the composition. If used, the proportion of moisture scavenger or drying agent in the composition is about 0 wt. % to 10 wt. % and in particular 0 wt. % to 2 wt. %, based on the total weight of the composition.

To improve shelf life further the LOCA composition can optionally include isocyanate stabilizer such as p-toluenesulfonyl isocyanate (PTSI), benzoyl chloride or ppm level of phosphoric acid.

Other additives useful in the disclosed composition in certain applications include air release agent; fungicide; flame retardant and combinations thereof. The total level of these additives will vary depending on amount of each particular additive needed to provide the adhesive composition with desired properties. The level of additives can be from 0 wt. % to 80 wt. %, based on the total weight of the composition.

The dual cure adhesive formulation will have a viscosity of 500 cPs to 100,000 cPs, more preferably 1000 cPs to about 50,000 cPs at room temperature. Preferably, a LOCA formulation prepared according to the present disclosure has a refractive index of from 1.3 to 1.6, most preferably from 1.35 to 1.55.

### EXAMPLES

### Example 1

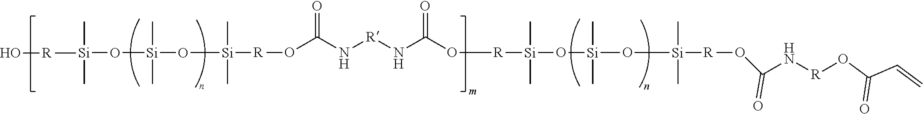

This is an example according to the present disclosure of a process for the formation of a silicone hybrid polymer that is partially end-capped with (meth)acrylate. The synthesis was carried out in a 500 ml pre-dried 3 necked round bottom flask equipped with a mechanical stirrer and dry nitrogen inlet. First, the silicone polymer KF 6003 silicone fluid, 100 g (18.7 mmol), was added to the flask and dried at 70° C. under vacuum for 1 hour to remove any traces of moisture. After cooling to 65° C., 5 mg each of the antioxidants butylated hydroxytoluene (BHT) and pentaerythritol tetrakis (3-(3,5-di-tert-butyl0-4-hydroxyphenyl) propionate) (Irganox® 1010) were added to the flask followed by addition of 25.9 mg of an acetone solution of the bismuth carboxylate catalyst K cat® XK-640. The flask was put under a nitrogen atmosphere and 2.99 g of IPDI (13.4 mmol) was added. After the addition was over, the reaction was further stirred for 3 hours at the same temperature. Then 0.76 g (5.4 mmol) of 2-isocyanatoethyl acrylate was added to the flask and the mixture further stirred for 1 hour to give a partially acrylate end-capped silicone hybrid polymer in quantitative yield.

### Example 2

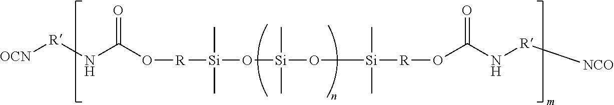

This is an example according to the present disclosure of a process for the formation of a silicone hybrid polymer that is isocyanate-terminated. The synthesis was carried out in a 500 ml pre-dried 3 necked round bottom flask equipped with a mechanical stirrer and dry nitrogen inlet. First, the silicone polymer KF 6002 silicone fluid, 286.8 g (91 mmol, OH #35), was added to the flask and dried at 70° C. under vacuum for 1 hour to remove any traces of moisture. After cooling to 65° C., 20 mg each of BHT and Irganox® 1010 were added to the flask followed by 5 drops of an acetone solution of K cat® XK-640 catalyst. The flask was put under a nitrogen atmosphere and 20.7 g of hexane-1, 6-diisocyanate (122 mmol) was added dropwise over a period of 20 minutes. After the addition was over, the reaction was further stirred for 3 hours at the same temperature. The isocyanate-terminated silicone hybrid polymer was transferred to an air tight syringe under a nitrogen atmosphere. Isocyanate titration was performed on this polymer to measure the % of isocyanate content in this polymer. Typically, when HDI was used, the wt % of isocyanate for this polymer was in the range 0.15 to about 0.25%.

### Example 3

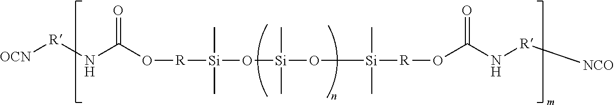

This is an example according to the present disclosure of a process for the formation of a silicone hybrid polymer that is isocyanate-terminated. The synthesis was carried out in a 500 ml pre-dried 3 necked round bottom flask equipped with a mechanical stirrer and dry nitrogen inlet. First, the silicone polymer KF 6003 silicone fluid, 256.11 g (49 mmol), was added to the flask and dried at 70° C. under vacuum for 1 hour to remove any traces of moisture. After cooling to 65° C., 20 mg each of BHT and Irganox® 1010 were added to the flask followed by 5 drops of an acetone solution of K cat® XK-640 catalyst. The flask was put under a nitrogen atmosphere and 11.33 g of hexane-1, 6-diisocyanate (67 mmol) was added dropwise over a period of 20 minutes. After the addition was over, the reaction was further stirred for 3 hours at the same temperature. The isocyanate-terminated silicone hybrid polymer was transferred to an air tight syringe under a nitrogen atmosphere. Isocyanate titration was performed on this polymer to measure the % of isocyanate content in this polymer (typical range was 0.15 to 0.25 wt %).

### Example 4

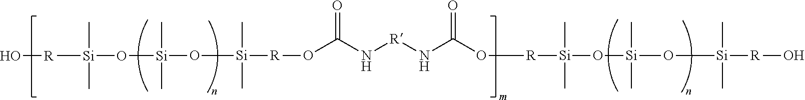

This is an example according to the present disclosure of a process for the formation of a chain extended silicone hybrid polymer that is hydroxy-terminated. The synthesis was carried out in a 500 ml pre-dried 3 necked round bottom flask equipped with a mechanical stirrer and dry nitrogen inlet. First, the silicone polymer KF 6003 silicone fluid, 265.2 g (51 mmol, OH #21.73), was added to the flask and dried at 70° C. under vacuum for 1 hour to remove any traces of moisture. After cooling to 65° C., 20 mg each of BHT and Irganox® 1010 were added to the flask followed by 5 drops of an acetone solution of K cat® XK-640 catalyst. The flask was put under a nitrogen atmosphere and 5.61 g of hexane-1, 6-diisocyanate (60 mmol) was added dropwise over a period of 20 minutes. After the addition was over, the reaction was further stirred for 3 hours at the same temperature. The hydroxyl-terminated silicone hybrid polymer was transferred to a container. The OH # was measured for this polymer and was determined to be 7.17. A similar procedure was used for the synthesis of other hydroxyl-terminated chain extended silicone hybrid polymers according to the present disclosure using other silicone diols and diisocyanates.

### Example 5

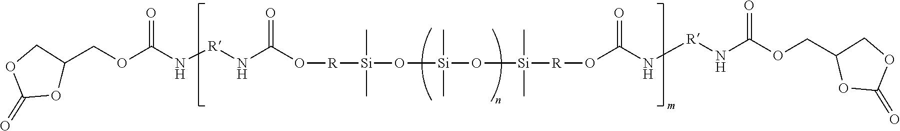

This is an example according to the present disclosure of a process for the formation of a chain extended silicone hybrid polymer that is cyclic carbonate-terminated. The synthesis was carried out in a 500 ml pre-dried 3 necked round bottom flask equipped with a mechanical stirrer and dry nitrogen inlet. First, the silicone polymer KF 6002 silicone fluid, 180.18 g (51 mmol, OH #32), was added to the flask and dried at 70° C. under vacuum for 1 hour to remove any traces of moisture. After cooling to 65° C., 20 mg each of BHT and Irganox® 1010 were added to the flask followed by 5 drops of an acetone solution of K cat® XK-640 catalyst. The flask was put under a nitrogen atmosphere and then 11.71 g of hexane-1, 6-diisocyanate (69 mmol) was added dropwise over a period of 20 minutes. After the addition was over, the reaction was further stirred for 3 hours at the same temperature. Then 5.19 g of 4-(Hydroxymethyl)-1,3-dioxalan-2-one (24 mmol) were added and the mixture further stirred for about 2 hours at the same temperature until Infrared analysis showed disappearance of the peak for isocyanate and then the material was transferred to a container.

### Example 6

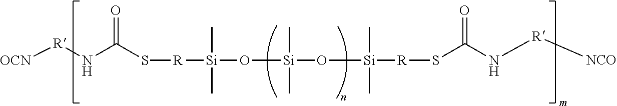

This is an example according to the present disclosure of a process for the formation of an isocyanate-terminated silicone-thiourethane hybrid polymer. The synthesis was carried out in a 500 ml pre-dried 3 necked round bottom flask equipped with a mechanical stirrer and dry nitrogen inlet. First, 146.1 g (46 mmol) of a mercapto-terminated silicone polymer, X-22-167B from Shin-Etsu, was added to the flask and dried at 70° C. under vacuum for 1 hour to remove any traces of moisture. After cooling to 65° C., 30 mg each of BHT and Irganox® 1010 were added to the flask followed by 10.24 g (60 mmol) of hexane-1, 6-diisocyanate under a nitrogen atmosphere. A catalytic amount, 2.5 g (24 mmol), of triethylamine was then added to the flask. After the addition was over, the reaction was further stirred for 3 hours at the same temperature. The isocyanate-terminated silicone hybrid polymer was transferred to a container.

### Example 7

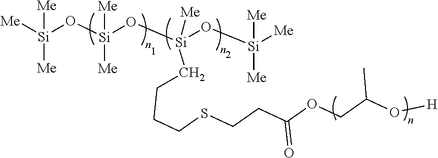

This is an example according to the present disclosure of a process for the formation of a multiple hydroxy functional silicone hybrid polymer. The synthesis was carried out in a 500 ml pre-dried 3 necked round bottom flask equipped with a mechanical stirrer and dry nitrogen inlet. A mixture of 16.84 g (27 mmol) of mercapto functionalized polydimethylsiloxane (PDMS), GP 367 from Genesee polymers corporation having a mercapto # of 35.8, 10.5 g of polypropylene glycol (PPG) monoacrylate (Mₙ 475, 22 mmol) and 1 ml (6 mmol) of triethylamine were stirred at room temperature for 48 hours. The originally milky mixture becomes a transparent liquid when the thiol-ene reaction is complete. Triethylamine was evaporated under reduced pressure at 40° C. using a rotovap for 3 hours. This gave the corresponding hydroxyl-functional PDMS-PPG hybrid polyol as a clear transparent liquid.

### Experimental Results

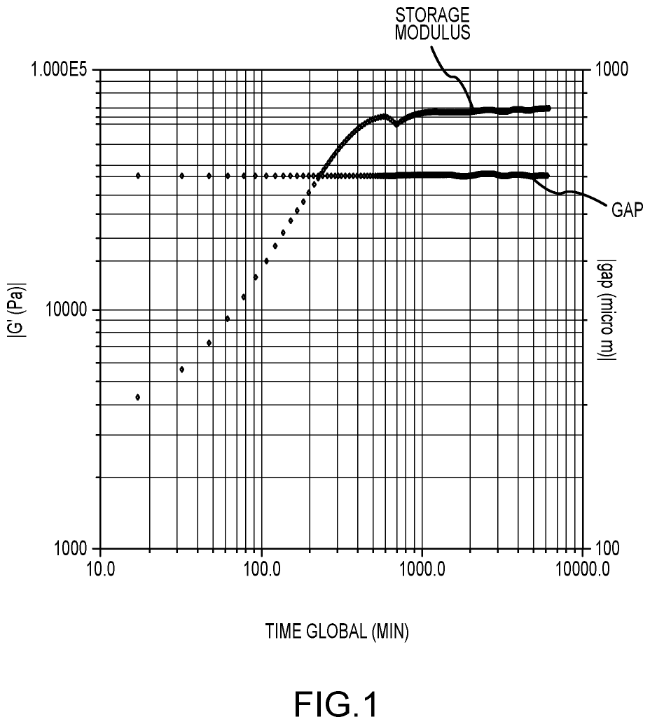

A dual cure LOCA study was performed using a LOCA formulation as shown in Formulation 1 below. The (meth)acrylate end-capped silicone hybrid polymer of example 1, the isocyanate-terminated silicone hybrid polymer of example 2 and a commercial silicone polyol X-22-4039 from Shin Etsu as a cross linker were blended together. The 2-methoxyethyl acrylate was used as a diluent to dissolve diphenyl(2,4,6-trimethylbenzoyl)phosphine oxide (TPO) photoinitiator in the presence of dibutyltin dioctoate as the shadow cure catalyst. The combined formulation was speed mixed. A specimen was prepared by placing a 600 micron thick layer of adhesive between two glass plates and curing the adhesive by UV exposure for 1 minute. A storage modulus vs time plot was run at room temperature using the 600 micron gap between the top and bottom glass plates. The storage modulus vs time plot of the dual cure Formulation 1 is shown in FIG. 1. After a UV cure time of 1 minute the graph shows that the shadow cure of Formulation 1 is essentially complete in about 1000 minutes, i.e. about 17 hours, at room temperature. By way of contrast, the commercial, single component silane-based LOCA formulation Loctite 8653, having both UV light and moisture cure mechanisms, requires 3-4 days to reach full cure at room temperature under the same conditions. Moreover, since the shadow cure does not depend on moisture ingress, full uniform cure in both exposed and unexposed areas of the adhesives can be achieved in less than 24 hours at room temperature using the presently disclosed system. The Shore 00 hardness for the above dual cure Formulation 1 was about 25. As can be seen from FIG. 1 there was no change in the gap size over the recorded time.

Formulation 1

| | | |
|---|---|---|
| silicone hybrid polymer of example 1 | 30.72 | g |
| silicone hybrid polymer of example 2 | 16.75 | g |
| 2-methoxyethyl acrylate | 1.85 | g |
| silicone polyol X-22-4039 (Shin Etsu) | 1.59 | g |
| TPO photoinitiator | 0.15 | g |
| dibutyltin dioctoate | 25 | mg |

| | |
|---|---|
| Shore 00 hardness of dual cured sample | 25 |

The Shore 00 hardness of the dual cure formulations according to the present disclosure can be tuned further either by changing the % end-capping in the acrylate silicone hybrid polymer or by replacing the silicone polyol cross linker X-22-4039 in part with a chain extended diol silicone hybrid polymer, one such example being example 4. Other commercially available silicone polyols or diols can also be used in the formulation to tune the Shore 00 hardness. Examples of commercial silicone polyols or diols that could be used, by way of example and not limitation, include silicone carbinols X-22-4015, KF6000, KF-6001, KF-6002, KF 6003, X-22-4952, X-22-4272, KF-6123, X-21-5841 and KF-9701, which are commercially available from Shin Etsu. Other examples include Silmer OHT A0, Silmer OH Di-10, Silmer OH di-50, Silmer OH C50, Silmer OH J10, Silmer OHT A0, Silmer OHT Di-10, Silmer OHT Di-100, Silmer OHT Di-400 and Silmer OHT E13, which are available from Siltech. Other silicone polyols that are obtained by thiol-ene reaction of multi mercapto functional silicones with polyalkylene glycol monoacrylate can also be used. Example 7 describes such a synthesis of a multi hydroxy functional silicone hybrid polymer according to the present disclosure which was obtained by thiol-ene reaction of mercapto functional silicones with polypropylene glycol monoacrylate. Examples of mercapto functional silicones that can be used in the synthesis of silicone-polyether hybrid diols or polyols by anionic thiol-ene reaction with polyetherdiol mono(meth)acrylate include KF-2001, KF-2004, X-22-167B, X-22-167C, which are commercially available from Shin Etsu or GP-970 and GP-367 mercapto functional silicone grades that are available from Genesee Polymers Corporation. Other metal catalysts such as Zr, Zn, Ti, Al can be used for the isocyanate polyol reaction. Many of these catalysts are commercially available and are environmentally friendly. The inventive dual cure formulation according to the present disclosure can be suitably designed to a 2K system, meaning a two component system, by separating the hydroxy functional and isocyanate functional silicone polymers into a 2K system.

Four formulations were used for optical aging studies, formulations 1-4. The formulations were prepared as described in the Formulation tables1-4 herein using the silicone hybrid polymer of example 1 and the silicone hybrid polymer of example 2 but varying the amount of silicone polyol cross linker, chain extended diol and acrylate diluent to tune the Shore 00 hardness and optical properties. Formulation 1, which used only the Shin-Etsu silicone polyol, X-22-4039 as the cross linker for shadow cure, showed a higher Shore 00 hardness of about 25 after dual cure. By way of contrast, formulation 2, which replaces some of the X-22-4039 polyol cross linker with the chain extended diol of example 4, showed a lower Shore 00 hardness, 12. This result shows that the Shore 00 hardness can be tuned by appropriate choice of the polyol/diol cross linkers in the formulation.

Formulation 2

| | | |
|---|---|---|
| silicone hybrid polymer of example 1 | 24.86 | g |
| silicone hybrid polymer of example 2 | 14.29 | g |
| 2-methoxyethyl acrylate | 1.75 | g |
| silicone polyol X-22-4039 (Shin Etsu) | 0.652 | g |
| silicone hybrid polymer of example 4 | 6.42 | g |
| TPO photoinitiator | 92 | mg |
| dibutyltin dioctoate | 17 | mg |

| | |
|---|---|
| Shore 00 hardness of dual cured sample | 12 |

Formulation 3 used a different acrylic diluent, which improved the optical properties especially after aging, see data below. This result shows that choice of organic diluent also plays an important role in optical properties.

Formulation 3

| | | |
|---|---|---|
| silicone hybrid polymer of example 1 | 10.55 | g |
| silicone hybrid polymer of example 2 | 7.81 | g |
| 2-(2-ethoxyethoxy)ethyl acrylate | 1.083 | g |
| silicone polyol X-22-4039 (Shin Etsu) | 0.63 | g |
| TPO photoinitiator | 57 | mg |
| dibutyltin dioctoate | 13 | mg |

| | |
|---|---|
| Shore 00 hardness of dual cured sample | 47 |

All of the above formulations, 1-3, used a tin catalyst for the shadow cure. For some applications, use of tin may be a concern because of potential environmental issues. A more environmentally friendly Zr catalyst was screened for use in the shadow cure reaction. K Kat® A 209, which is a zirconium chelate complex dissolved in a reactive diluent and t-butyl acetate. This catalyst showed good reactivity in a shadow cure reaction, which appeared to be completed in less than 24 hours at room temperature (formulation 4). This formulation is identical to formulation 3 except that Zr catalyst is used for the shadow reaction. The shore 00 hardness for this formulation is identical to formulation 3, which shows that full shadow cure reaction can be achieved with Zr catalyst as well.

Formulation 4

| | | |
|---|---|---|
| silicone hybrid polymer of example 1 | 10.08 | g |
| silicone hybrid polymer of example 2 | 7.51 | g |
| 2-(2-ethoxyethoxy)ethyl acrylate | 1.036 | g |
| silicone polyol X-22-4039 (Shin Etsu) | 0.604 | g |
| TPO photoinitiator | 54 | mg |
| K-Kat ® A 209 | 18 | mg |

| | |
|---|---|
| Shore 00 hardness of dual cured sample | 45 |

The Formulations 1-4 were subjected to optical aging studies and compared to a commercial comparative control not in accordance with the present disclosure, Loctite 8653. Cured films, 250 microns thick, from LOCA Formulations 1-4 and Loctite 8653 were subjected to an optical aging test and the results are shown below. Overall, Formulations 1 and 2 showed superior aging results in the 85° C. at 85% relative Humidity (R.H.) test for 1000 hours compared to the control formulation while the QUV 1000 hour test result was slightly better for the control formulation. The QUV is an accelerated weathering tester that reproduces the damage caused by sunlight, rain and dew. It is noteworthy that the control formulation, Loctite 8653, contains a UV stabilizer, which plays a key role in improving the UV aging results. Formulations 1-4 did not include a UV stabilizer and addition of one would be expected to improve their QUV test results.

Formulation 1

| | | 500 hours | | | 1000 hours | | |
|---|---|---|---|---|---|---|---|
| Optical test | | 85° C./ | | | 85° C./ | | |
| Datacolor 650 | Initial | 85% R.H. | 90° C. | QUV | 85% R.H. | 90° C. | QUV |
| Haze | 0.1 | 0.4 | 1.2 | 0.2 | 0.4 | 1.3 | 0.5 |
| Color | 0.02 | 0.11 | 0.11 | 0.57 | 0.22 | 0.15 | 0.58 |
| % Transmittance | 99.8 | 99.6 | 99.62 | 97 | 99.8 | 100 | 98.5 |

Formulation 2

| | | 500 hours | | | 1000 hours | | |
|---|---|---|---|---|---|---|---|
| Optical test | | 85° C./ | | | 85° C./ | | |
| Datacolor 650 | Initial | 85% R.H. | 90° C. | QUV | 85% R.H. | 90° C. | QUV |
| Haze | 0.1 | 0.6 | na | 1.5 | 0.7 | na | 0.6 |
| Color | 0.0 | 0.05 | na | 0.75 | 0.1 | na | 0.35 |
| % Transmittance | 99.6 | 100 | na | 96.55 | 100 | na | 98.8 |

A slightly superior optical aging result was obtained when 2-(2-ethoxyethoxy)ethyl acrylate was used a diluent as shown below for Formulation 3. The haze result was superior to the result obtained when 2-methoxyethyl acrylate was used as the diluent.

Formulation 3

| | | 640 hours | | | 1000 hours | | |
|---|---|---|---|---|---|---|---|
| Optical test | | 85° C./85% | | | 85° C./ | | |
| Datacolor 650 | Initial | RH | 90° C. | QUV | 85% RH | 90° C. | QUV |
| Haze | 0 | 0.3 | 0.7 | 0.1 | 0.2 | 0.8 | 0 |
| Color | 0.19 | 0.43 | 0.37 | 0.71 | 0.64 | 0.4 | 0.66 |
| % Transmittance | 99.64 | 99.2 | 99.49 | 98.44 | 99.06 | 99.8 | 98.67 |

No deterioration of optical properties was seen when the tin catalyst was replaced with a Zr catalyst for shadow cure as in Formulation 4. The optical aging and Shore 00 hardness were similar to those observed for Formulation 3.

Formulation 4

| | | 500 hours | | | 1000 hours | | |
|---|---|---|---|---|---|---|---|
| Optical test | | 85° C./85% | | | 85° C./ | | |
| Datacolor 650 | Initial | RH | 90° C. | QUV | 85% RH | 90° C. | QUV |
| Haze | 0 | 0.6 | 0.2 | 0.1 | 0.1 | 0.2 | 0.2 |
| Color | 0 | 0.13 | 0.33 | 1.14 | 0.37 | 0.35 | 0.9 |
| % Transmittance | 99.9 | 99.84 | 99.76 | 96.55 | 99.54 | 99.75 | 98.14 |

The results for the commercial control Loctite 8653 are shown below.

| | | 500 hours | | | 1000 hours | | |
|---|---|---|---|---|---|---|---|
| Optical test | | 85° C./ | | | 85° C./ | | |
| Datacolor 650 | Initial | 85% RH | 90° C. | QUV | 85% RH | 90° C. | QUV |
| Haze | 0.6 | 1.6 | na | 0.4 | 1.4 | na | 0.5 |
| Color | 0.0 | 0.24 | na | 0.1 | 0.55 | na | 0.1 |
| % Transmittance | 99.75 | 99.55 | na | 99.47 | 98.8 | na | 100 |

All of the formulations shown above can be split into a 2-part system. However, the components were mixed as a 1K system for the reported optical aging test. To see if a formulation dispensed as a two-part system would give significantly different optical aging result, Formulation 5, shown below, was dispensed as a two-part formulation in a 250 micron thick film and after dual curing, the optical properties were evaluated. The results are also shown below.

Formulation 5

| Components | Part A | Part B |
|---|---|---|
| silicone hybrid polymer of example 1 | | 51.73% |
| silicone hybrid polymer of example 2 | 38.48% | |
| 2-(2-ethoxyethoxy)ethyl acrylate | 5.71% | |
| silicone polyol X-22-4039 (Shin Etsu) | | 3.42% |
| TPO photoinitiator | 0.30% | |
| K-Kat ® A 209 | 0.09% | |

Formulation 5

| Optical | | | | | | | |
|---|---|---|---|---|---|---|---|
| test | | 496 hours | | | 1118 hours | | |
| Data- | | 85° C./ | | | 85° C./ | | |
| color | | 85% | | | 85% | | |
| 650 | Initial | RH | 90° C. | QUV | RH | 90° C. | QUV |
| Haze | 0.7 | 0.7 | 2.4 | 0.8 | 0.8 | 3.2 | 0.7 |
| Color | 0.39 | 1.0 | 1.5 | 0.73 | 1.24 | 1.7 | 0.63 |
| % | 99.6 | 98 | 96 | 96.6 | 98.6 | 96.2 | 99.7 |
| Trans- | | | | | | | |
| mittance | | | | | | | |

Shadow curability of cyclic carbonate functionalized silicone hybrid polymers and aliphatic amine functional silicones was demonstrated as shown in formulation 6 in a two-part dual cure formulation. Aliphatic amine reaction with 5-membered cyclic carbonates to give hydroxy functional polyurethanes is well known and this technology is being used as an alternative to moisture cure polyurethanes because of toxicity issue associated with isocyanates. The reaction is slow at room temperature but can be accelerated by catalytic amidine/guanidine type bases or by a combination of a Lewis acid and a Lewis base. This cyclic carbonate-amine reaction was for shadow cure in a dual cure formulation containing silicone hybrid polymers where the UV cure is obtained by the aforementioned acrylate capped silicone hybrid polymer and shadow curing coming from the cyclic carbonate functional silicone hybrid polymer with aliphatic amine functional silicones.

Formulation 6

| Components | Part A | Part B |
|---|---|---|
| silicone hybrid polymer of example 1 | | 45.72% |
| silicone hybrid cyclic carbonate of | 35.17% | |
| example 5 | | |
| 2-(2-ethoxyethoxy)ethyl acrylate | 5% | |
| Poly(dimethylsiloxane), amine | | 13.71% |
| functional (GP-6) | | |
| TPO photoinitiator | 0.20% | |
| Guanidine | | 0.2% |

Shore 00 hardness after UV cure = 5,
and after 10 days at r.t. = 20

While the shadow cure reaction of silicone hybrid cyclic carbonates and amine functional silicones was much slower than that between silicone isocyanates and silicone hybrid diols and/or silicone polyols, the shadow cure reaction was still occurring as evidenced by increase in Shore 00 hardness after UV cure and standing at r.t. for 10 days as shown in formulation 6

A 5-membered cyclic carbonate functional silicone hybrid polymer of example 5 used in formulation 6 according to the present disclosure was made by capping the isocyanate-terminated silicone hybrid polymer with a commercially available glycerol carbonate.

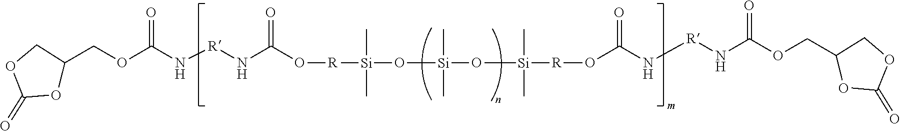

Examples of aliphatic amine functional silicones that can be used for shadow curing with cyclic carbonate functional silicones include but are not limited to X-22-3939A, KF-877, KF-889, KF-868, KF, 865, KF-864, KF-8012, KF-8008, X-22-1660B-3, X-22-9409, PAM-E, KF-8010, X-22-161A, X22-161B, which are available from Shin-Etsu, GP-4, GP-6, GP-581, GP-344, GP-997, GP-342, GP-316 that are available from Genesee polymers.

The foregoing disclosure has been described in accordance with the relevant legal standards, thus the description is exemplary rather than limiting in nature. Variations and modifications to the disclosed embodiment may become apparent to those skilled in the art and do come within the scope of the disclosure. Accordingly, the scope of legal protection afforded this disclosure can only be determined by studying the following claims.

We claim:

1. A dual curable composition including:
a UV curable, partially or fully (meth)acrylate end-capped, silicone hybrid polymer;
a two-part (2K) shadow curable composition comprising a first component and a second component reactive with the first component;
one or more of organic diluent, photoinitiator and catalyst; and
optionally one or more adjuvants.

2. The dual curable composition of claim 1, being a two part composition, wherein the UV curable, silicone hybrid polymer and one of the shadow curable first or second components is in one composition part and the other of the shadow curable first or second components is in the other composition part.

3. The dual curable composition of claim 1, wherein the UV curable silicone hybrid polymer has structure I: 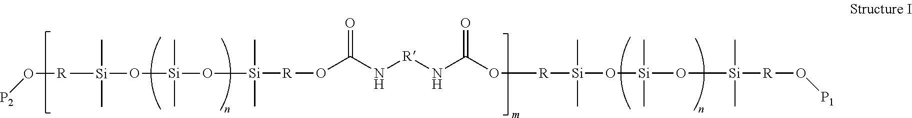
wherein R and R′ are each independently hydrocarbylene segments having 1 to 30 carbon atoms or heterocarbylene segments having 1 to 30 carbon atoms and one or more of nitrogen, oxygen or sulfur atoms in the backbone;
P₁ and P₂ can be independently H or a polymerizable group derived from reaction of a hydroxyl group with an isocyanate containing (meth)acrylate group with the proviso that only one of P₁ and P₂ can be H; and
n and m are independently 1 to 10,000.

4. The dual curable composition of claim 1, wherein the UV curable silicone hybrid polymer has structure I: 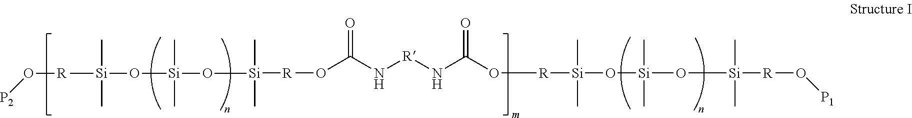
wherein R and R′ are each independently organic segments selected from the group consisting of linear or branched alkylenes, cycloalkylenes, bicycloalkylenes, tricycloalkylenes, linear or branched cycloalkylenes, linear or branched alkenylenes, arylenes, aralkylenes, arylbicycloalkylenes, aryltricycloalkylenes, bicycloalkylarylenes, tricycloalkylarylenes, bisphenylenes, cycloalkylarylenes, polyoxyalkylenes, heterocycloalkylene, heterocycloarylenes and mixtures thereof; optionally, the alkylenes, cycloalkylenes, alkenylenes, arylenes, aralkylenes, arylbicycloalkylenes, aryltricycloalkylenes, bicycloalkylarylenes, tricycloalkylarylenes, bisphenylenes, cycloalkylarylenes, polyoxyalkylenes, heterocycloalkylene, heterocycloarylenes and mixtures thereof and having 1 to 30 carbon atoms and one or more of nitrogen, oxygen or sulfur atoms in the backbone;
P₁ and P₂ can be independently H or a (meth)acrylate group with the proviso that only one of P₁ and P₂ can be H; and
n and m are independently 1 to 10,000.

5. The dual curable composition of claim 1, wherein the UV curable silicone hybrid polymer has structure I: 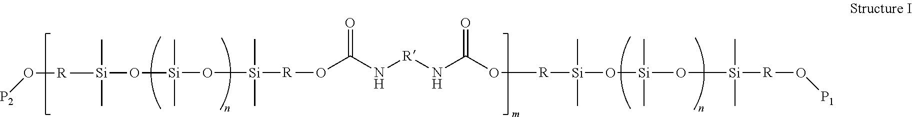
wherein R and R′ are each independently selected from an alkylene or cycloalkylene having 4 to 20 carbon atoms and alkylene or cycloalkylene ethers having 4 to 20 carbon atoms and one or more oxygen atoms;
P₁ and P₂ can be independently H or a polymerizable group derived from reaction of a hydroxyl group with an isocyanate containing (meth)acrylate group with the proviso that only one of P₁ and P₂ can be H; and
n and m are independently 1 to 10,000.

6. The dual curable composition of claim 1, being a two part composition, wherein the shadow curable first component comprises an isocyanate-terminated silicone hybrid polymer and the shadow curable second components comprises at least one of a hydroxy-terminated silicone hybrid polymer or a hydroxyl containing silicone polyol polymer

7. The dual curable composition of claim 1, being a two part composition, wherein the shadow curable first component comprises a cyclic carbonate terminated silicone hybrid polymer and the shadow curable second components comprises an amine containing silicone hybrid polymer or an amine containing silicone polymer.

8. The dual curable composition of claim 1, further comprising photoinitiator, catalyst, UV stabilizer and optionally comprising at least one of organic diluent and adjuvants.

9. The dual cure curable polymer composition of claim 1, wherein said composition has a high refractive index between about 1.45 and about 1.60.

10. A liquid optically clear adhesive comprising the dual curable polymer composition according to claim 1.

11. An automotive display comprising the dual curable polymer composition according to claim 1.

12. A dual curable polymer composition comprising:
a) a UV curable part including a polymer of structure I 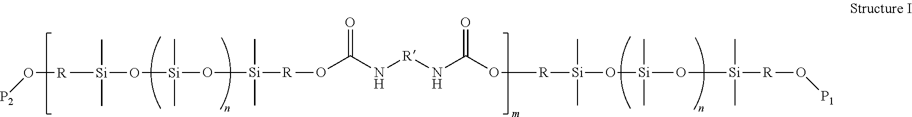
wherein R and R′ are each independently hydrocarbylene segments having 1 to 30 carbon atoms or heterocarbylene segments having 1 to 30 carbon atoms and one or more of nitrogen, oxygen or sulfur atoms in the backbone;
P₁ and P₂ can be independently H or a polymerizable group derived from reaction of a hydroxyl group with an isocyanate containing (meth)acrylate group with the proviso that only one of P₁ and P₂ can be H; and
n and m are independently 1 to 10,000;
b) a shadow curable part comprising:
1) an isocyanate containing polymer according to structure II 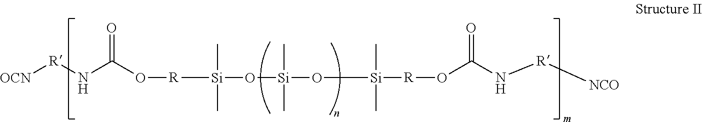
wherein R and R′ are each independently hydrocarbylene having 1 to 30 carbon atoms or heterocarbylene having 1 to 30 carbon atoms and one or more of nitrogen, oxygen or sulfur atoms in the backbone; and
n and m are each independently 1 to 10000;
2) a diol polymer according to structure III, a silicone polyol polymer according to structure IV, a silicone polyol polymer according to structure IVa and combinations thereof; 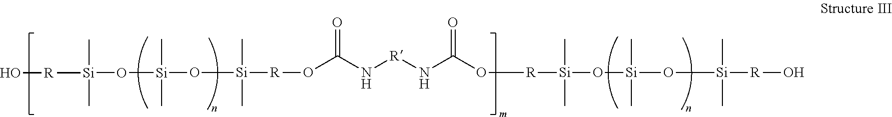
wherein R and R′ are each independently hydrocarbylene segments having 1 to 30 carbon atoms or heterocarbylene segments having 1 to 30 carbon atoms and one or more of nitrogen, oxygen or sulfur atoms in the backbone.
n and m are each independently 1 to 10000; 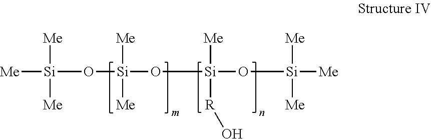
wherein R is a hydrocarbylene having 1 to 30 carbon atoms or heterocarbylene having 1 to 30 carbon atoms and one or more of nitrogen, oxygen or sulfur atoms in the backbone;
m is 1 to 10,000 and n is 2 to 1000; 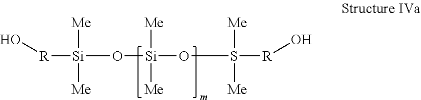
wherein R is a hydrocarbylene having 1 to 30 carbon atoms or heterocarbylene having 1 to 30 carbon atoms and one or more of nitrogen, oxygen or sulfur atoms in the backbone; and
m is 1 to 10,000 and preferably 1 to 1,000;
c) a photoinitiator;
d) a catalyst for the isocyanate containing polymer shadow cure reaction; and
e) optionally at least one of organic diluent, UV stabilizer and adjuvant.

13. The dual curable polymer composition of claim 12, wherein said composition is a two-part system.

14. The dual cure curable polymer composition of claim 12, wherein said composition has a high refractive index between about 1.45 and about 1.60.

15. A liquid optically clear adhesive comprising the dual curable polymer composition according to claim 12.

16. An automotive display comprising the dual curable polymer composition according to claim 12.

17. A dual curable polymer composition comprising:
a) a UV curable part including a polymer of structure I 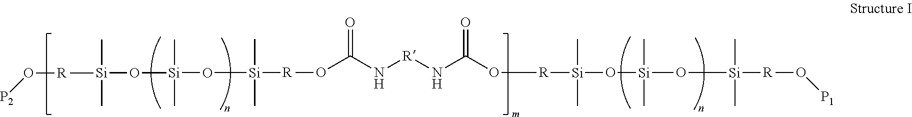
wherein R and R′ are each independently hydrocarbylene segments having 1 to 30 carbon atoms or heterocarbylene segments having 1 to 30 carbon atoms and one or more of nitrogen, oxygen or sulfur atoms in the backbone;
P₁ and P₂ can be independently H or a polymerizable group derived from reaction of a hydroxyl group with an isocyanate containing (meth)acrylate group with the proviso that only one of P₁ and P₂ can be H; and
n and m are independently 1 to 10,000;
b) a shadow curable part comprising:
1) a cyclic carbonate according to structure V 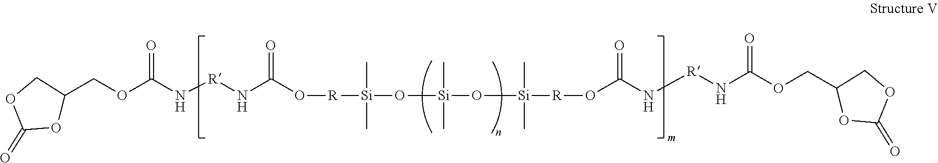
wherein R and R′ are each independently hydrocarbylene segments having 1 to 30 carbon atoms or heterocarbylene segments having 1 to 30 carbon atoms and one or more of nitrogen, oxygen or sulfur atoms in the backbone; and
n and m are each independently 1 to 10000;
2) one or more amines according to the structures VI and VII 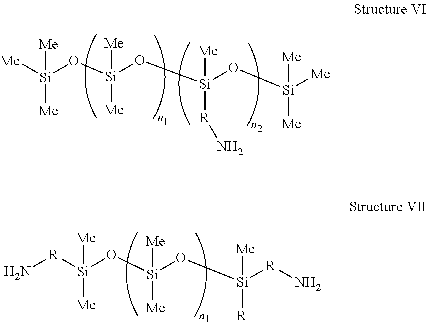
wherein R is a hydrocarbylene having 1 to 30 carbon atoms or heterocarbylene having 1 to 30 carbon atoms and one or more of nitrogen, oxygen or sulfur atoms in the backbone;
n1 is 1 to 10,000; and n2 is 2 to 10,000;
c) a photoinitiator;
d) a catalyst for the isocyanate containing polymer shadow cure reaction; and
e) optionally at least one of organic diluent, UV stabilizer and adjuvant.

18. The dual cure curable polymer composition of claim 17, wherein said composition has a high refractive index between about 1.45 and about 1.60.

19. A liquid optically clear adhesive comprising the dual curable polymer composition according to claim 17.

20. An automotive display comprising the dual curable polymer composition according to claim 17.
